(19) United States
(12) Patent Application Publication
(10) Pub. No.: US 2009/0307995 A1
(43) Pub. Date: Dec. 17, 2009

(54) ROOF CONSTRUCTION JOINTS MADE OF SANDWICH PANELS

(75) Inventor: Ulrich Schwartau, Port d Andratx (ES)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INNOVIDA FACTORIES, LTD., George Town (KY)

(21) Appl. No.: 12/138,572

(22) Filed: Jun. 13, 2008

(51) Int. Cl. E04B 7/02; B29C 65/50

(52) U.S. Cl. 52/93.1; 156/71

(57) ABSTRACT

A roofing joint includes a union member that joins two sandwich panels. An edge portion of the sandwich panels is cut and removed, e.g., by a miter cut. The edge portion is generally cut based on the pitch of the roof for the structure. The roof joint is formed by aligning the union member between the edges of the panels. Thus, the panel cores are in contact with opposing surfaces of the union member, such that the cores of panels are in physical contact with the union member. In one embodiment, the union member extends above the surface of the roofing joint (e.g., extends above the first outer surface of the panels). In another embodiment, the union member extends below the surface of the second outer surface of the panels. A bonding material is injected or otherwise adhered to areas of intersection for the first and second panels and the union member to protect the joint from environmental elements (e.g., water penetration, snow, hail, etc.). In another embodiment, a channel guide is secured relative portion to the roof to direct liquid (e.g., water, rain, sleet, snow, etc.) that accumulates on the roof to a desired location.

### TECHNICAL FIELD OF THE INVENTION

The present invention relates generally to constructing buildings, and more particularly, to forming a roofing joint for connecting sandwich panels in such a manner to form at least a portion of a roof of a building.

### DESCRIPTION OF THE RELATED ART

There is an increasing demand for low-cost buildings such as houses, warehouses and office space. The demand for low cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In other areas of the world, poverty may make it too costly for people to build houses or other buildings with conventional materials.

The demand for low-cost housing also is high in areas afflicted by war or natural disasters, such as hurricanes, tornados, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials and may be scarce or expensive to obtain. Thus, there exists a need for alternative materials and techniques for constructing buildings that use advanced material technologies to increase the speed of construction and also reduce or lower ownership costs.

### SUMMARY

The present invention provides an alternative to conventional construction materials and techniques. Buildings, such as houses, commercial buildings, warehouses, or other structures can be constructed by composite sandwich panels, which have an insulative core and one or more outer layers. The buildings can be constructed by gluing several panels together, and usually screws, rivets, nails, etc., are not needed for such connections. Generally, composite sandwich panels offer a greater strength to weight ratio over traditional materials that are used by the building industry. The composite panels are generally as strong as, or stronger than, traditional materials including wood-based and steel-based structural insulation panels, while being lighter in weight. The composite sandwich panels also can be used to produce light-weight buildings, such as floating houses or other light-weight structures. Because they weigh less than traditional building materials, composite sandwich panels are generally less expensive to transport.

Sandwich panels generally are more elastic or flexible than conventional materials such as concrete, steel or brick and, therefore, monolithic buildings made from sandwich panels are more durable than buildings made from conventional materials. For example, sandwich panels also may be non-flammable, waterproof and very strong and durable, and in some cases able to resist hurricane-force winds (up to 300 Kph (kilometers per hour)). The panels also may be resistant to the detrimental effects of algae, fungicides, water, and osmosis. As a result, buildings constructed from sandwich panels are better able to withstanding earthquakes, floods, tornados, hurricanes, fires and other natural disasters than buildings constructed from conventional materials.

Two construction elements, e.g., solid panels and/or sandwich panels, etc., can be connected together with a union member to form a roofing joint. As used herein the phrase “roofing joint” means a joint that is used to secure and/or to form a portion of a roof of a building or other structure from one or more construction elements.

In order to connect two or more sandwich panels to form a roof joint, an edge portion from an edge of the sandwich panels is cut (e.g., miter cut) and removed to form a peak of the roof. The edge portion is generally cut based on the pitch of the roof for the structure. The roof joint is formed by aligning a union member between the angle edges of the sandwich panels that form the roof peak. The angle edge of the sandwich panels that form the roof are in contact with the union member, such that the outer layers and the panel cores of the sandwich panels are in physical contact with the union member. In another embodiment, bonding material may be applied between the union member and the angle edges of the sandwich panels to secure the sandwich panels to the union member and to prevent moisture from entering the interface between the sandwich panels and the union member. The union member generally extends above the surface of the roofing joint (e.g., extends above the first outer surface of the panels). In another embodiment, the union member extends below the surface of the second outer surface of the panels. A bonding material is injected or otherwise adhered to areas of intersection for the first and second panels and the union member to protect the joint from environmental elements (e.g., water penetration, snow, hail, etc.). In another embodiment, a channel guide may be secured to and/or positioned on or near the roof in order to guide and/or route liquid (e.g., water, rain, snow, etc.) that accumulates on the roof to an appropriate location (e.g., drainage spout, gutter, etc.).

One aspect of the invention relates to a roofing joint including: a first sandwich panel having a first outer layer and a second outer layer spaced from the first outer layer by a panel core and a first angle edge comprised of an edge portion of the panel core and an edge portion of the first outer layer; a second sandwich panel having a first outer layer and a second outer layer spaced from the first outer layer by a panel core and a second angle edge comprised of an edge portion of the panel core and an edge portion of the first outer layer; and a union member having a first outer layer and a second outer layer, wherein the first outer layer of the union member is secured to the first angle edge and the second outer layer of the union member is secured to the second angle edge by a bonding material.

Another aspect of the invention relates to a roofing joint including: a first sandwich panel having a first outer layer and a second outer layer spaced from the first outer layer by a panel core and a first angle edge comprised of a first edge portion of the panel core and a first edge portion of the first outer layer and a second angle edge comprised of a second edge portion of the panel core and a second edge portion of the second outer layer; a second sandwich panel having a first outer layer and a second outer layer spaced from the first outer layer by a panel core and a first end; and a channel guide secured to the second sandwich panel, wherein the channel guide forms at least a portion of a channel to direct liquid flow from a roof.

Another aspect of the present invention relates to a method a forming a roofing joint with two sandwich panels, wherein each sandwich panel has a first outer layer and a second outer layer spaced from the first outer layer by a panel core, the method including: removing an edge portion of each sandwich panel to form an angle edge, the angle edge comprising a portion of the panel core and an edge of the first outer layer; and arranging the panels to place the angle edges in contact with a union member, wherein the union member has a first outer layer and a second outer layer, wherein the first outer layer of the union member is secured to the angle edge of the first sandwich panel and the second outer layer of the union member is secured to the angle edge of the second panel by a bonding material for forming a roof joint on an associated structure.

Another aspect of the invention relates to a channel guide including: a first outer layer; and a second outer layer secured to the first outer layer by a bonding material, wherein the first outer layer includes a first portion that form at least a portion of flow path for liquid that accumulates on an associated roof, and the first outer layer also includes a second portion for securing the channel guide to an associated sandwich panel.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIG. 1 is an environmental view of an exemplary monolithic structure built from composite materials.

FIG. 2 is an isometric view of an exemplary sandwich panel.

FIG. 3 is a front cross-sectional view of an exemplary roofing joint in accordance with aspects of the present invention.

FIG. 4 is a sectional view of the exemplary roofing joint along line 4-4 of FIGS. 1 and 3 in accordance with aspects of the present invention.

FIG. 5 is a front cross-sectional view of another exemplary roofing joint in accordance with aspects of the present invention.

FIG. 6 is a sectional view of the roofing joint along line 6-6 of FIGS. 1 and 5 in accordance with aspects of the present invention.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used only for convenience when referring to the figures. For example, “upward,” “downward,” “above,” or “below” merely describe directions in the configurations shown in the figures. The components can be oriented in any direction and the terminology should therefore be interpreted to include such variations. Furthermore, while described primarily with respect to house construction, it will be appreciated that all of the concepts described herein are equally applicable to the construction of any type building, such as warehouses, commercial buildings, factories, apartments, etc.

The structures described herein are built with composite materials, such as sandwich panels. Sandwich panels, which may be formed from synthetic materials, provide a light-weight and less expensive alternative to conventional raw materials, e.g., wood, concrete, metal, etc. Sandwich panels are usually connected or joined together with a high-strength bonding material, such as epoxy or glue, and conventional materials, such as nails and screws, are not usually needed. The result is a strong and durable monolithic (e.g., single unit) structure, as described further below.

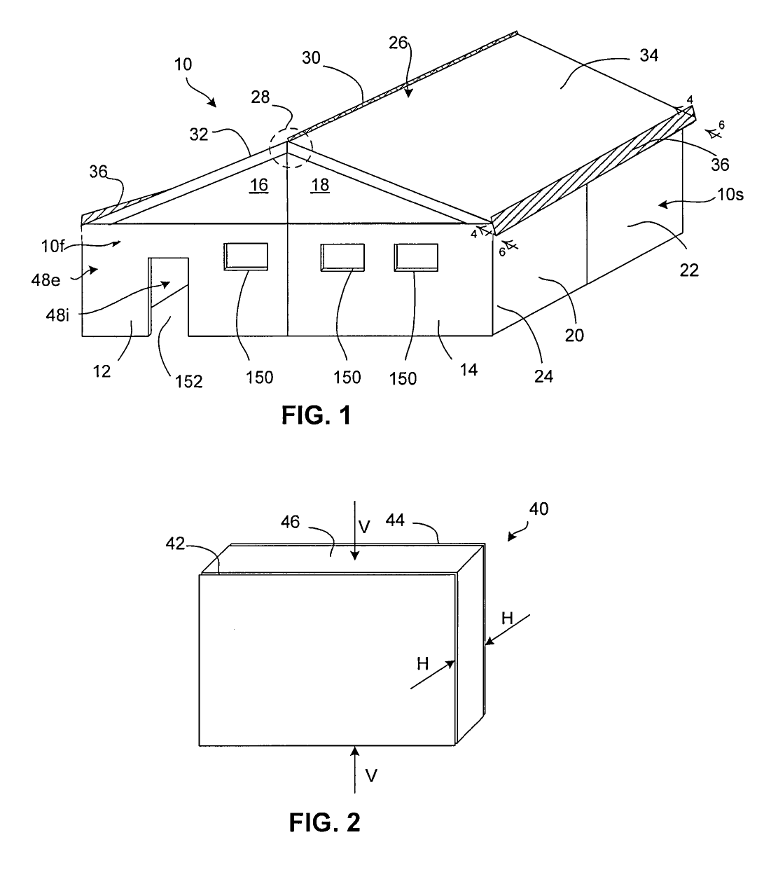

Referring to FIG. 1, an exemplary monolithic structure 10, such as a house, is built from a plurality of sandwich panels. The house 10 includes four sandwich panels 12, 14, 16, 18 connected together to form a front wall 10f and two sandwich panels 20, 22 connected together to form a side wall 10s. The front wall 10f and side wall 10s are connected to one another by an angle joint 24. The house 10 has another side wall (not shown) and a rear wall (not shown) and a roof 26. The roof 26 includes at least one roofing joint 28, which includes a union member 30 and at least two sandwich panels 32 and 34. Generally, the roof 26 includes multiple sandwich panels placed adjacent, above and/or below another to cover substantially all of the monolithic structure 1O. The roof 26 optionally may include channel guide 36 for routing liquid (e.g., water, rain, sleet, snow, etc.) that accumulates on the roof. The structure of the roofing joint 28 is discussed in detail below.

An exemplary sandwich panel 40 is illustrated in FIG. 2. As used herein, the phrase “sandwich panel” means a panel having two outer layers 42, 44 separated by a core 46. The outer layers 42, 44 of the sandwich panel 40 are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 42, 44 (also referred to as laminates) may be relatively thin with respect to the panel core 46. The outer layers 42, 44 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

It will be appreciated that the outer layers 42, 44 may be made thicker by layering several layers of reinforcement material on top of one another. The thickness of the reinforcement material also may be varied to obtain thicker outer layers 42, 44 with a single layer of reinforcement material. Further, different reinforcement materials may be thicker than others and may be selected based upon the desired thickness of the outer layers.

The core 46 separates the outer layers 42, 44 of the sandwich panel 40. The core 46 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary core materials include honeycomb that can be made of polypropylene, non-flammable impregnated paper or other composite materials. It will be appreciated that these materials insulate the interior of the structure and also reduce the sound or noise transmitted through the panels, e.g., from one outer surface to the other or from an exterior 48e to an interior 48i of the building, etc. The core 46 may be any desired thickness and may be, for example, 30 mm (millimeters)-100 mm (millimeters) thick; however, it will be appreciated that the core can be thinner than 30 mm (millimeters) or thicker than 100 mm (millimeters) as may be desired. In one embodiment, the core is approximately 41 mm (millimeters) thick.

The outer layers 42, 44 are adhered to the core 46 with the matrix materials, such as the resin mixture. Once cured, the outer layers 42, 44 of the sandwich panel 40 are firmly adhered to both sides of the panel core 46, forming a rigid building element. It will be appreciated that the resin mixture also may include additional agents, such as, for example, flame retardants, mold suppressants, curing agents, hardeners, etc. Coatings may be applied to the outer layers 42, 44, such as, for example, finish coats, paint, ultraviolet (UV) protection, water protection, etc.

The core 46 may provide good thermal insulation properties and structural properties. The outer layers 42, 44 may add to those properties of the core and also may protect the core 46 from damage. The outer layers 42, 44 also may provide rigidity and support to the sandwich panel 40.

The sandwich panels may be any shape and size. In one embodiment, the sandwich panels are rectangular in shape and may be several meters, or more, in height and width. The sandwich panels also may be other shapes and sizes. The combination of the core 46 and outer layers 42, 44 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 2) and 2 tons per square meter in the horizontal direction (indicated by arrows H in FIG. 2). The sandwich panels may have other strength characteristics as will be appreciated in the art.

Internal stiffeners may be integrated into the panel core 46 to increase the overall stiffness of the sandwich panel 40. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of 15 cm (centimeters), 25 cm, 50 cm, or 100 cm. Alternatively, the stiffeners may be placed at different angles, such as a 45-degree angle with respect to the top and bottom of the panel, or at another angle, as may be desired.

As shown in FIG. 1, sandwich panels 32, 34 may be used to form at least a portion of the roof 26. The above description of the exemplary sandwich panel 40 also is applicable to sandwich panels 32, 34. The roof 26 includes one more roofing joints 28 for securing two or more sandwich panels (e.g., sandwich panels 32, 34) together. Generally, the roof 26 includes multiple panels positioned adjacent, above and/or below one another to cover the entire monolithic structure 10. The edges of the sandwich panels that attach to a union member 30 are cut at an angle that may correspond to the desired peak of the roof 26.

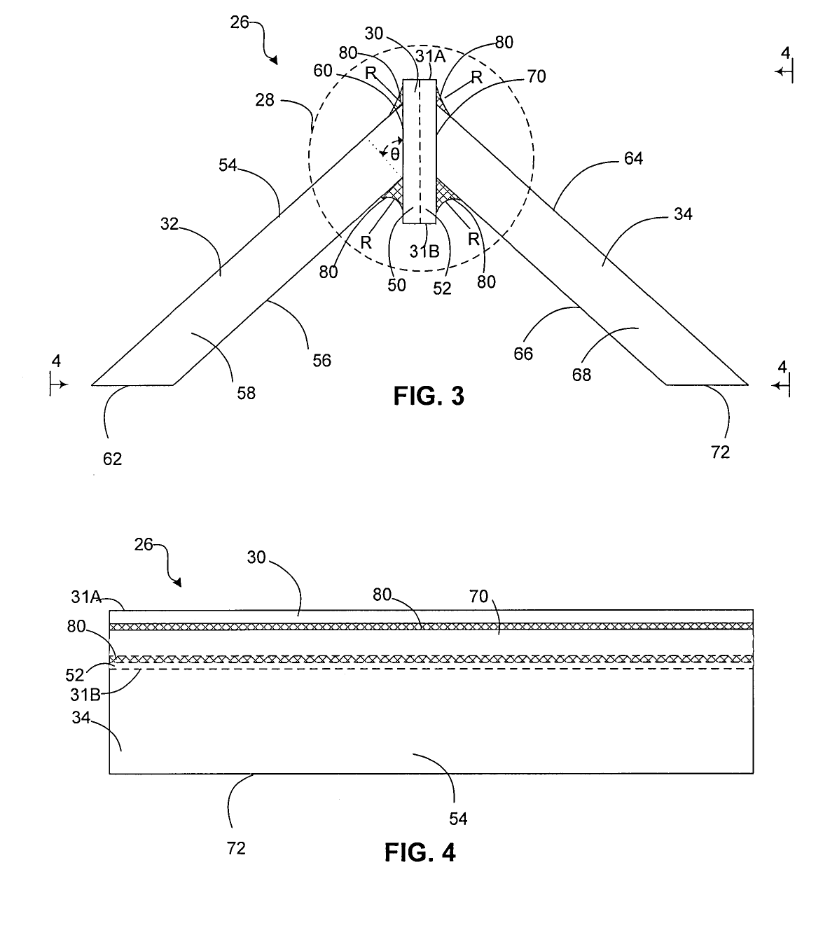

Referring to FIGS. 3 and 4, an exemplary roofing joint 28 that connects two or more sandwich panels 32, 34 to form a roof peak is illustrated. The roofing joint 28 includes a union member 30 secured between sandwich panels 32, 34 along a portion of the roof 26. The union member 30 has a first outer layer 50 and a second outer layer 52. The union member 30 is made of full composite material (e.g., a one or two layer laminate as used in outer layers 42, 44).

One of ordinary skill in the art will readily appreciate that the figures illustrating the union member 30 are not drawn to scale. The union member 30 is shown larger to illustrate various aspects of the present invention. As set forth below, a two layer laminate would have a thickness of approximately 2-3 millimeters. A single layer laminate would have a thickness of about 1-2 millimeters.

The first outer layer 50 and the second outer layer 52 are adhered to each other with the matrix materials, such as the resin mixture, discussed above. Once cured, the outer layers 50 and 52 are firmly adhered to each other, thereby forming a rigid building element. It will be appreciated that the resin mixture also may include additional agents, such as, for example, flame retardants, mold suppressants, curing agents, hardeners, etc. Coatings may be applied to the outer layers 50, 52, such as, for example, finish coats, paint, etc. In addition, one or more tie layers may be incorporated between the outer layers 50, 52 to enhance bonding of the materials. In addition, the outer layers may be spaced by a union core layer.

The outer layers 50, 52 of the union member 30 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

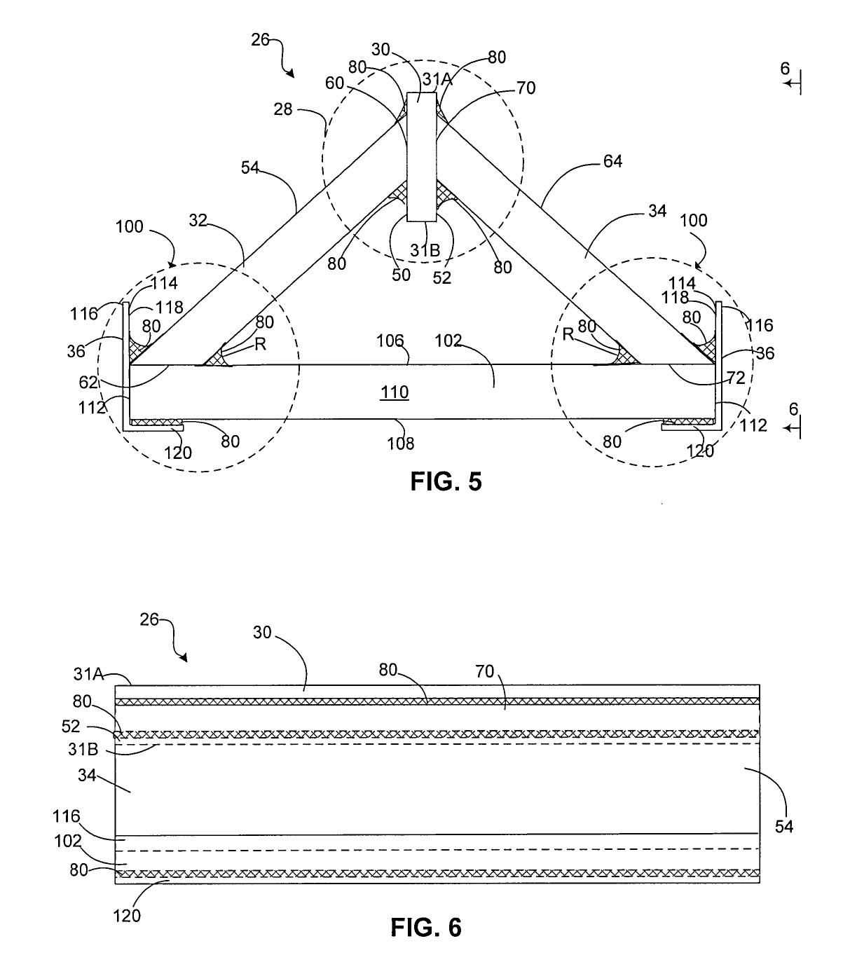

As shown in FIG. 3, the first outer layer 50 is secured to sandwich panel 32 and the second outer layer 52 is secured to sandwich panel 34. The union member 30 may be any desired shape. For example, the union member 30 may have a rectangular cross-section as illustrated in FIGS. 3 and 5. Like the sandwich panel 40 discussed above, the sandwich panel 32 includes first and second outer layers 54, 56, panel core 58, and first and second ends 60, 62. Also, the sandwich panel 34 includes first and second outer layers 64, 66, panel core 68, and first and second ends 70, 72.

The union member 30 includes a first end 31A that generally extends beyond the first outer layers 54, 64 of the sandwich panels 32, 34, respectively. The union member 30 may also include a second end 3 1B that generally extends beyond the second outer layer 56, 66 of the sandwich panels 32, 34, respectively. In one embodiment, the first and second ends 31A, 31B extend less than 100 millimeters beyond the respective outer layers 56, 66. In another embodiment, the first and second ends 31A, 31B extend about 10 millimeters beyond the respective outer layers (e.g., 54, 64, 56, 66). Extending the ends 31A and 31B beyond the respective outer layers (e.g., 54, 64, 56, 66) provides a convenient mechanism for application of a bonding agent to the respective interfaces between the union member 30 and the sandwich panels 32, 34, as discussed below.

The first end 60 of the sandwich panel 32 may be cut at an angle to form an angle edge of the sandwich panel 32. The first end 60 generally is cut at an angle that corresponds to the desired angle (θ) of the roof peak. The angle edge generally includes the outer layers 54, 56 and the panel core 58. The second end 62 may be un-cut or cut as desired, depending on the design of the structure 10.

The first end 70 of the sandwich panel 34 may be cut at an angle to form an angle edge of the sandwich panel 34. The angle edge generally includes the outer layers 64, 66 and the panel core layer 68. The second end 72 may be un-cut or cut as desired, depending on the design of the structure 10.

The first end 60 of sandwich panel 32 and the first end 70 of the sandwich panel 34 may have an angle edge that is dependent on the desired slope and/or pitch of the roof 26.

As illustrated in FIG. 3, the first end 60 and the first end 70 are secured to the union member 30. For example, the first outer layer 50 of the union member 30 is secured to the angle edge of the first end 60 of the sandwich panel 32. Likewise, the second outer layer 52 of the union member 30 is secured with the angle edge of the first end 70 of the sandwich panel 34. In one embodiment, the angle edges may be substantially identical, such that the union member 30 is substantially parallel with one or more side walls of the structure 10 when constructed as illustrated in FIG. 1.

As shown in FIG. 3, the sandwich panels 32, 34 may be connected to one another through union member 30. Generally, the first ends 60, 70 of the panel members 32, 34 are cut transversely to form an angle θ (shown in FIG. 3) that is equal to or less than 90-degrees. The angles may be formed at any desirable angle by any means, e.g., by a miter cut. In one embodiment, the outer layers of the first ends 54, 64 of the sandwich panels may be in contact with the first and second outer layers 50, 52 of the union member 30, respectively. In addition, a bonding material 80 may be applied between the first ends 60, 70 and the union member 30. The first end 60 may include an edge portion that includes one or more of the first outer layer 54, second outer layer 56 and/or panel core 58. Likewise, first end 70 may include an edge portion that includes one or more of the first outer layer 64, second outer layer 66 and/or panel core 68. It is generally desirable to have the first ends 60, 70 to have substantially the same angle, so that the sandwich panels 32, 34 align flush with the union member 30. For example, it is desirable that the outer layers and panel cores of sandwich panels 32, 34 are in contact and/or align with the union member 30, such that the union member 30 is perpendicular to the base of the structure 10.

In one embodiment, the union member 30 generally is in contact with the panel cores 58, 68 so as to form an interface along the roofing joint 28, which generally extends across at least a portion of the roof 26, as shown in FIG. 4. The interface between the sandwich panels 32, 34 and the union member 30 may be sealed by applying bonding material 80 along the roofing joint 28. The bonding material 80 rigidly may hold or connect the sandwich panels 32, 34 to the union member 30 and also generally spans across and seals the roofing joint 28 to prevent moisture from entering the roofing joint 28. As stated above, bonding material 80 may also be applied between first ends 60, 70 of the sandwich panels 32, 34 and the union member 30.

As shown in FIGS. 3 and 4, bonding material 80 may be applied along one or more portions of the roofing joint 28. For example, as illustrated in FIGS. 3 and 4, bonding material 80 may be applied along the interface of the first outer layer 54 of the sandwich panel 32 and the first outer layer 50 of the union member 30; along the interface of the first outer layer 64 of the sandwich panel 34 and the second outer layer 52 of the union member 30; along the interface of the second outer layer 56 of the sandwich panel 32 and the first outer layer 50 of the union member 30; and along the second outer layer 66 of the sandwich panel 34 and second outer layer 52 of the union member 30.

The bonding material 80 may be applied in any desirable manner. For example, the bonding material may be applied by injection, spreading, spraying, molding, etc. The bonding material 80 rigidly holds or connects the sandwich panels 32, 34 to the union member 30 and also spans across and seals the entranceway to the interface between the panel cores 32, 34 and the union member 30. The bonding material 80 may be curved, molded, or formed to create a rounded corner having a radius R, e.g., as shown in FIGS. 3 and 5. The rounded corner may distribute forces along one or more building elements.

The resulting roofing joint 28, inhibits or reduces moisture penetration into the roofing joint 26 from the exterior 48e of the house 10 to the interior 48i of the house 10. The length of the radius may be about 15 mm (millimeters)-40 mm (millimeters) in length. The length of the radius R may be selected based upon the thicknesses of the outer layers, e.g., the outer layers 54, 56, 64, 66 according to a desired ratio. The desired ratio of the radius R to the thickness of the outer layers may be about seven to one (7:1), or more, e.g., 8:1 or an even larger ratio. For instance if the outer layers 54, 56, 64, 66 are about 2 mm (millimeters) thick, the radius R would be at least about 14 mm (millimeters), and may be thicker, if desired, or adjusted based upon a desired strength or other factor. In another example, the outer layers 54, 56, 64, 66 may be 3 mm (millimeters) thick and the radius R is at least about 21 mm (millimeters) or more.

As discussed above, the union member 30 includes ends 31A and 31B that extend beyond the outer surfaces of one or more panel. The ends 31A and 31B provide a convenient structure to adhere the bonding material 80 in order to seal and to secure the sandwich panels 32, 34 to the union member 30. In one embodiment, the ends 31A, 31B extend past the respective outer layers a sufficient amount to provide a suitable support for application of the bonding material 80. For example, it is preferable that the ends 31A and 31B of the union member extend beyond the respective outer layers of the sandwich panels 32, 34 a distance of less than 100 millimeters and, more preferably, about 10 millimeters. Such distances have been found to provide sufficient support for application of the bonding material between the respective building elements.

The bonding material 80, shown in FIGS. 3 and 4, may be any suitable bonding material such as epoxy, epoxy resin, glue, adhesive, adhering material or another bonding material (these terms may be used interchangeably and equivalently herein).

The bonding material used to connect the panels with the union member has the same general thermal expansion characteristics as the materials used to construct the sandwich panel and/or the union member. In one embodiment, the bonding material is more flexible or bendable than the sandwich panels, and may, for example, be four or five times more flexible than the panels. The flexibility of the bonding material, therefore, reduces the likelihood than the joints of the monolithic structure will break or split, and also transmits loads from one panel to another, across the joint. The bonding material may include filling components, such as, fiberglass or a fiberglass and resin mixture, and may, for example, be microfiber and Aerosil®. The bonding material may be long term resistant against water and UV rays.

Referring to FIGS. 5 and 6, an exemplary roofing joint 100 for securing a channel guide 36 to the roof 26 is illustrated. The channel guide 36 secures to the roof joint 100 and provides a convenient mechanism to direct or otherwise guide liquids (e.g., water, rain, sleet, snow, etc.) that accumulate on the roof 26 to an appropriate destination for removal from the roof (e.g., a drainage spout).

As shown in FIG. 5, the roofing joint 100 includes a first sandwich panel 32, a second sandwich panel 102 and a channel guide 36. The first sandwich panel has a first outer layer 54 and a second outer layer 56 spaced from the first outer layer 54 by a panel core 58, as discussed above. The first sandwich panel 32 includes an angle edge at the second end 62, which includes at least an edge portion of the panel core 58 and an edge portion of the first outer layer 54.

The second sandwich panel 102 also includes a first outer layer 106 and a second outer layer 108 spaced from the first outer layer by a panel core 110. The second sandwich panel 102 also includes at least one end 112. The second sandwich panel may provide support for the roof 26, including sandwich panels 32, 34 and any other sandwich panels that may be used to form the roof 26. In one embodiment, sandwich panel 102 is formed from a portion of an exterior wall (e.g., front wall 10f, side wall 10s, rear wall, etc.) and generally extends perpendicular to the union member 30, as shown in FIG. 5. While sandwich panel 102 is illustrated as a single sandwich panel, it would be obvious to one of ordinary skill in the art that one or more sandwich panels may be used to form sandwich panel 102 depending on the size and shape of the roof 26.

The channel guide 36 is formed from a first outer surface 114 and a second outer surface 1 16. The first and second outer surfaces 114, 116 are made from the same materials as discussed above with respect to the first and second outer surfaces 32, 34, 42, 44, 54, 56, 64, 66. The first and second outer surfaces 114, 116 are bonded and/or laminated together using any suitable bonding agent. The channel guide may also be made of one part, e.g. a two layer laminate, without bonding).

The first outer surface 114 has a guide portion 118 that forms a guide for directing the flow of liquid (e.g., water, rain, snow, etc.) that accumulates on the roof 26. The guide portion 118 generally extends above the roof panel (e.g., sandwich panel 32, 34) in order to facilitate capture of the water, rain, and/or snow. The guide portion 118 may extend above the roof panel, any desirable amount. It is preferable that the guide portion 118 extends above the edge 62 of the roofing panel a sufficient amount to prevent environmental accumulants from overflowing the guide portion 118.

The first outer surface 114 may also include a securing portion 120. The securing portion 120 may be used to secure the channel guide to one or more sandwich panels (e.g., sandwich panel 102). In one embodiment, illustrated in FIG. 5, the guide portion 118 and the securing portion 120 are planar elements that are configured substantially perpendicular to each other. As illustrated in FIGS. 5 and 6, a bonding material 80 may be placed between the securing portion 120 and the sandwich panel 102 to secure the sandwich panel to the roof 26. In addition, bonding material 80 also may be spread between guide portion 118 and roof panels 32, 34. Likewise, bonding material also may be spread between guide portion 118 and edge portion 112 of the sandwich panel 102 for additional support and to prevent moisture from entering the interface.

The bonding material 80 secures the channel guide 36 to one or more sandwich panels (e.g., sandwich panels 54, 102). The bonding material 80 may also be applied on the first surface 114 of the channel guide 36 and the first outer surface 64 of the sandwich panel 34 to prevent moisture from entering the roofing joint 100.

It is generally desirable for the channel guide 36 to route or otherwise direct liquid (e.g., water, rain, snow, etc.) that accumulates on a roof to a drainage port or other such device that removes the liquid from the roof and routes the water to a sewer or other desired location. Since a channel guide 36 generally relies on gravity to cause the liquid to flow, it is desirable to install the channel guide along portions of the roof in such a manner to facilitate such flow (e.g., by inclining the channel guide or portions thereof to facilitate flow to the drainage spout or other such structure.

Referring back to FIG. 1, the sandwich panel may be customized by cutting and removing a portion of the panel 12, 14 to form an opening for a window 150. The window opening 150 may be cut to any desired size to accommodate the installation of any size window. Similarly, a portion of the panel 12 may be cut and removed to form an opening or doorway 152. Although the sandwich panels (e.g., 12, 14, 20, 22) of FIG. 1 are shown with window 150 and door 152 cutouts, it will be appreciated that the panel can be customized in any manner desired to meet the specifications of an architectural or design plan. For example, referring to FIG. 1, the panel 14 includes several window openings 150 and no door opening, while panels 20, 22 are solid walls. The sandwich panels also may be cut in other designs to accommodate other roof, wall, etc. arrangements. It also will be appreciated that while the windows, door and roof are described as being cut from a solid sandwich panel, the openings may be molded or otherwise formed in the panel.

Although the invention has been shown and described with respect to a certain preferred embodiment or embodiments, it is obvious that equivalent alterations and modifications will occur to others skilled in the art upon the reading and understanding of this specification and the annexed drawings.

What is claimed is:

1. A roofing joint comprising:
a first sandwich panel having a first outer layer and a second outer layer spaced from the first outer layer by a panel core and a first angle edge comprised of an edge portion of the panel core and an edge portion of the first outer layer;
a second sandwich panel having a first outer layer and a second outer layer spaced from the first outer layer by a panel core and a second angle edge comprised of an edge portion of the panel core and an edge portion of the first outer layer;
a union member having a first outer layer and a second outer layer, wherein the first outer layer of the union member is secured to the first angle edge and the second outer layer of the union member is secured to the second angle edge by a bonding material for forming a roof joint on an associated structure.

2. The roofing joint of claim 1, wherein the union member is a laminate strip formed of at least two materials joined together with bonding material.

3. The roofing joint of claim 1, wherein the union member includes a first end that extends above the first outer layer of the first sandwich panel and first outer layer of the second sandwich panel.

4. The roofing joint of claim 3, wherein the union member extends less than 100 millimeters above the first outer layer of the first sandwich panel and first outer layer of the second sandwich panel.

5. The roofing joint of claim 3, wherein the union member extends about 10 millimeters above the first outer layer of the first sandwich panel and first outer layer of the second sandwich panel.

6. The roofing joint of claim 3, wherein the union member includes a second end that extends outward from the second outer layer of the first sandwich panel and second outer layer of the second sandwich panel.

7. The roofing joint of claim 6, wherein the union member extends outward less than 100 millimeters from the second outer layer of the first sandwich panel and second outer layer of the second sandwich panel.

8. The roofing joint of claim 6, wherein the union member extends outward about 10 millimeters from the second outer layer of the first sandwich panel and second outer layer of the second sandwich panel.

9. The roofing joint of claim 1, wherein the bonding material is an adhesive.

10. The roofing joint of claim 9 further including bonding material in contact with the first outer layer of the first sandwich panel and the first outer layer of the union member.

11. The roofing joint of claim 10 further including bonding material in contact with the first outer layer of the second sandwich panel and the second outer layer of the union member.

12. The roofing joint of claim 9 further including bonding material in contact with the second outer layer of the first sandwich panel and the first outer layer of the union member.

13. The roofing joint of claim 12 further including bonding material in contact with the second outer layer of the second sandwich panel and second outer layer of the union member.

14. A roofing joint comprising:
a first sandwich panel having a first outer layer and a second outer layer spaced from the first outer layer by a panel core and a first angle edge comprised of a first edge portion of the panel core and a first edge portion of the first outer layer and a second angle edge comprised of a second edge portion of the panel core and a second edge portion of the second outer layer;
a second sandwich panel having a first outer layer and a second outer layer spaced from the first outer layer by a panel core and a first end; and
a channel guide secured to the second sandwich panel, wherein the channel guide forms at least a portion of a channel to direct liquid flow from a roof.

15. The roofing joint of claim 14, wherein the second angle edge of the first sandwich panel is in contact with the first outer layer of the second sandwich panel.

16. The roofing joint of claim 14, wherein the channel guide has a first surface that forms the at least portion of the flow path and a second surface secured to the second outer surface of the second sandwich panel.

17. The roofing joint of claim 16, wherein the first surface of the channel guide and the second surface are substantially perpendicular with respect to another.

18. The roofing joint of claim 17, wherein the second angle edge is secured to the second panel by a bonding material placed adjacent the second angle edge and the channel guide.

19. The roofing joint of claim 18, wherein the channel guide includes a first outer surface and a second outer face.

20. The roofing joint of claim 19, wherein the second outer surface of the channel guide forms the first surface of the channel guide that forms the at least portion of the flow path and second outer surface of the channel guide includes the second surface of the channel guide secured to the second outer surface of the second sandwich panel.

21. A method a forming a roofing joint with two sandwich panels, wherein each sandwich panel has a first outer layer and a second outer layer spaced from the first outer layer by a panel core, the method comprising:
removing an edge portion of each sandwich panel to form an angle edge, the angle edge comprises a portion of the panel core and an edge of the first outer layer;
arranging the panels to place the angle edges in contact with a union member, wherein the union member has a first outer layer and a second outer layer, wherein the first outer layer of the union member is secured to the angle edge of the first sandwich panel and the second outer layer of the union member is secured to the angle edge of the second panel by a bonding material for forming a roof joint on an associated structure.

22. The method of claim 21 further including applying the bonding material to the first outer layer of the first sandwich panel and the first outer layer of the union member.

23. The method of claim 22 further comprising applying the bonding material to the first outer layer of the second sandwich panel and the second outer layer of the union member.

24. The method of claim 23 further comprising applying the bonding material to the second outer layer of the first sandwich panel and the first outer layer of the union member.

25. The method of claim 24 further comprising applying the bonding material to the second outer layer of the second sandwich panel and the second outer layer of the union member.

26. A channel guide comprising:
a first outer layer;
a second outer layer secured to the first outer layer by a bonding material, wherein the first outer layer includes a first portion that form at least a portion of flow path for liquid that accumulates on an associated roof, and the first outer layer also includes a second portion for securing the channel guide to an associated sandwich panel.

27. The channel guide of claim 26, wherein the first portion of the channel guide and the second portion are substantially perpendicular with respect to one another.

28. The channel guide of claim 27, wherein the second portion of the channel guide is secured to the associated sandwich panel by a bonding material.
